(19) United States
(12) Patent Application Publication
(10) Pub. No.: US 2003/0056146 A1
(43) Pub. Date: Mar. 20, 2003

(54) Method for suggesting corrective action in response to resource constraint

(76) Inventors: Tracy K. Freeman, Meridian, ID (US); Mark E. Hodges, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/952,941

(22) Filed: Sep. 14, 2001

(51) Int. Cl. G06F 11/00

(52) U.S. Cl. 714/25

(57) ABSTRACT

A printer having fast memory and slow memory receives a print job from an information handling system. If at least one page of the print job is larger than the available capacity of either fast memory or slow memory, the printer generates a message offering one or more options for handling the resource constraint within the printer memory.

### FIELD OF THE INVENTION

This invention relates to printing, and more particularly to handling resource constraints at a printer.

### BACKGROUND

It is standard in the art to connect a computer or other information handling system to a printer in order to print text, images, graphics or other information from the computer. Typically, a software application running on the computer is utilized to generate a print job from a data file stored in the computer. That print job is typically spooled to a hard disk or other memory storage device within the computer, meaning that the print job is stored within the computer such that the user can continue working with the software application. The print job is then transmitted to the printer one page at a time. Random-access memory (RAM) within the printer receives each page and processes it. Some printers include a hard disk to which data from RAM is spooled, depending on the size of the print job. After the data forming each page is printed to a print medium, it may be deleted or overwritten within the printer by data representing the next page in the print job, or stored within the printer for reuse.

When a data file containing color images is selected for printing, the print job that is generated may be very large. For example, a single 8½″×11″ or A4 size page of a color image may occupy almost 100 megabytes of storage space. Even more storage space may be required for color images to be printed to larger sheets of paper, such as 11″×17″ paper. A print job having a number of such pages can exceed a gigabyte in size. The problem may be exacerbated by the use of more-advanced formats for image storage. For example, image files are often stored as JPEG files, which utilize JPEG compression. Such compression allows for a high-quality image, but also results in a print job of a larger size than would result from a use of a less-advanced format, such as a bitmap format. As a result, when image files are selected for printing and a print job is generated, one or more pages of the print job may be larger than the RAM capacity within the printer. An error message is typically generated at the printer when the first of those oversized pages is received, informing the user that inadequate memory exists in the printer to print out the remainder of the job. However, the user is not informed how much memory would be required, nor are any remaining pages of the print job printed, even if those remaining pages are each within the memory storage capacity of the printer. Even if each individual page can be processed by the RAM within the printer, a multiple-page print job can rapidly fill the hard disk within the printer, resulting in another error message generated at the printer that indicates that the disk is full. Thus, the user may be frustrated in his or her attempt to print out a data file.

### SUMMARY

A printer having a memory storage capacity receives a print job from an information handling system, and takes action if the print job exceeds its memory resources.

In one aspect of the invention, if the memory storage capacity required to process at least one page of the print job is larger than the capacity of the fast memory within the printer, the printer stores data related to the difference between the fast memory capacity required and the fast memory capacity available.

In another aspect of the invention, if the size of at least one page of a print job is larger than the fast memory capacity of the printer, the printer generates a message offering one or more options for handling the resource constraint within the fast memory. These options may include resubmitting the print job at a different compression level to produce a print job having a smaller size, reducing the size of a RAM disk or disk cache stored in the fast memory, or suggesting an upgrade to fast memory that would allow the print job to be successfully completed. This message may be transmitted back to the information handling system, displayed on a display unit on the printer, printed on print media by the printer, or otherwise communicated to a user.

In another aspect of the invention, if the memory storage capacity required to handle at least one page of the print job is larger than the free capacity of the slow memory within the printer, the printer stores data related to the difference between the slow memory capacity required and the free capacity of the slow memory.

In another aspect of the invention, if the size of at least one page of a print job is larger than the free capacity of the slow memory, the printer generates a message offering one or more options for handling the resource constraint within the slow memory. These options may include deleting one or more files stored within the slow memory or suggesting an upgrade to the slow memory. This message may be transmitted back to the information handling system, displayed on a display unit on the printer, printed on print media by the printer, or otherwise communicated to a user.

In another aspect of the invention, if the size of at least one page of a print job is larger than the fast memory or slow memory capacity of the printer, the printer continues to print the remainder of the print job if any pages remain in it. The printer may print only those pages that are within its fast memory or slow memory capacity, partially print those pages that exceed its fast memory or slow memory capacity, or take other action to print as much of the print job as possible.

In another aspect of the invention, if the size of at least one page of a print job is larger than the fast memory or slow memory capacity of the printer, information relating to the shortfall of storage capacity within the printer is transmitted to a remote location via a communications network. That information can be used by a user or information handling system at the remote location to target information such as advertising or other marketing material to the user or owner of the printer.

In another aspect of the invention, the printer is connected to a remote location via a communications network, through which it can receive periodic updates relating to upgrades it suggests. These periodic updates may include new suggestions for upgrades, new prices, promotions, or other information.

The invention will be more fully understood upon consideration of the detailed description below, taken together with the accompanying drawings.

### BRIEF DESCRIPTION OF THE DRAWINGS

FIG. 1 is a block diagram of a printer connected to an information handling system.

FIG. 2 is a flow chart of a method for handling large print jobs transmitted from the information handling system to the printer.

FIG. 3 is a block diagram of the printer connected to a remote information handling system via a communications network.

Use of the same reference symbols in different figures indicates similar or identical items.

### DETAILED DESCRIPTION

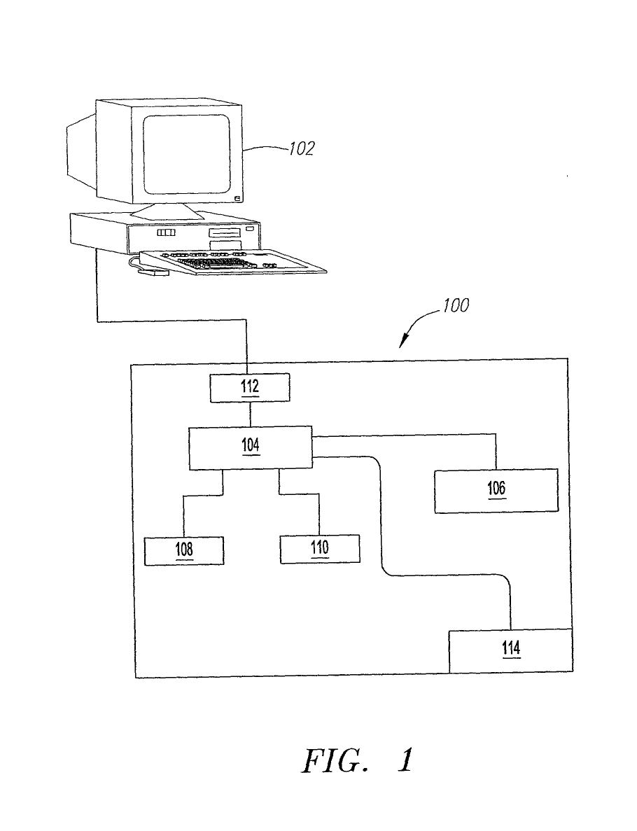

Referring to FIG. 1, a printer 100 is shown, connected to an information handling system 102 via a communications interface 112. The information handling system 102 can be any device adapted to handling and process data, such as a personal computer, a terminal, a thin client, an Internet appliance, a personal digital assistant, a laptop computer or other device. The communications interface 112 may be a modem, a network interface card, or any other device that allows the printer 100 to communicate with the information handling system 102. The information handling system 102 may be connected to the printer 100 through a single cable, a local area network, a wide area network, a communications network such as the Internet, a wireless connection, or any other connection through which the contents of the print job can be transmitted to the printer 100.

The printer 100 includes a controller 104 connected to the communications interface 112. The controller 104 may be a microprocessor, an application-specific integrated circuit (ASIC), a field-programmable gate array (FPGA), or other device. Among other functions, the controller 104 processes information transmitted from the information handling system 102 to the printer 100, and controls the operation of the printer 100. The controller 104 also, if needed, converts the print job information received from the information handling system 102 into an array of dots or other information for printing.

A marking engine 106 is connected to the controller 104. The marking engine 106 prints information received from the controller 104 onto print media. The marking engine 106 is an ink- or toner-based marking system that receives print media and prints images upon it via a laser cartridge, an ink cartridge, an LED print head, an electrostatic print head, or another device by which images are printed on media.

Both fast memory 108 and slow memory 110 are connected to the controller 104. Fast memory 108 receives each page of a print job and stores each page while it is processed by the controller 104. The controller 104 then stores each processed page in slow memory 110, where the processed pages remain until printed by the marking engine 106. The fast memory 108 may be random-access memory (RAM) or any other type of memory storage device adapted to receive and send information relatively fast in comparison with the slow memory 110. The slow memory 110 may be a hard disk drive, removable cartridge disk drive, optical disk, FLASH memory, or any other type of memory storage device adapted to receive and send information relatively slow in comparison with the fast memory 108. Although FLASH memory is faster than a rotating disk for read operations, it is significantly slower for write operations. Because write operations are where resource shortfalls are detected, FLASH memory is considered slow memory. The slow memory 110 has a larger storage capacity than the fast memory 108. The fast memory 108 and slow memory 110 may be located within the printer 100, or may be outside of and connected to the printer 100. For example, the slow memory 110 may be a hard drive placed near and connected to the printer 100. Alternately, only fast memory 108 is connected to the controller 104, and no slow memory 110 is used. If so, the functions provided by slow memory 110, as described above, are performed instead by fast memory 108.

The printer 100 may include a display 114 connected to the controller 104. The display 114 may be a liquid-crystal display (LCD), light-emission display (LED), or any other device capable of displaying information.

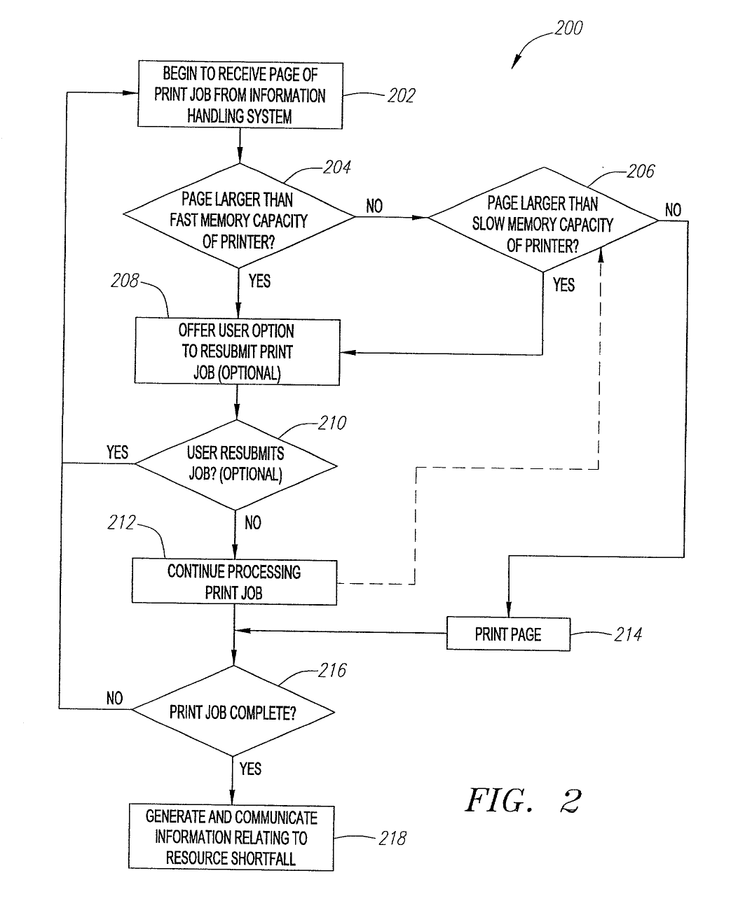

Referring as well to FIG. 2, a process 200 for handling large print jobs is shown. The order of the blocks of the process 200 is exemplary, and the blocks can be reordered or otherwise arranged unless expressly noted. In block 202, the printer 100 begins to receive a page of a print job from the information handling system 102. The generation of a print job at the information handling system 102 is standard, as described above. The print job includes one or more pages of material to be printed by the printer 100. As described above, the information handling system 102 transmits one page of the print job at a time to the printer 100. The controller 104 of the printer 100 receives the print job via the communications interface 112. As the data that forms a page is received by the controller 104, the controller 104 routes that incoming data to the fast memory 108, where it can be accessed quickly by the controller 104 for processing. Alternately, the controller 104 may first route the data to the slow memory 110 and then to the fast memory 108, or may alternate between the memories 108, 110, or may apportion incoming data between the memories 108, 110 in a different manner.

In block 204, the controller 104 determines whether the size of the page that has begun to be received in block 202 is larger than the capacity of the fast memory 108 of the printer 100. Each page within the print job is followed by a page marker that signals the end of that page. The page marker may be a set of bits, or one or more bytes, set to particular values. Alternately, the page marker may be the page number, where the change in page number indicates the end of a page. The page marker may take another form, if desired. Alternately, the boundary of a page may be measured or signaled in another way than by use of a page marker. The controller 104 looks for the page marker in the incoming data to determine the end of the page received. If a page marker is detected by the controller 104 before the fast memory 108 capacity of the printer 100 has been reached, then the page received in block 202 is within the capacity of the fast memory 108. Thus, the entire page can be stored in the fast memory 108. The process then moves to step 206, which is described in greater detail below.

If in block 204 no page marker is detected by the controller 104 before the capacity of the fast memory 108 has been reached, then the page that had begun to be received in block 202 is larger than the capacity of the fast memory 108. That is, there is a resource shortfall within the printer 100, where the fast memory 108 is the resource. The shortfall results from an inadequate amount of physical fast memory 108 installed in the printer 100. The shortfall may be related to the use of a portion of the fast memory 108 as a RAM disk. A RAM disk is a portion of the fast memory 108 set aside to emulate slow memory 110. Similarly, the shortfall may be related to the use of a portion of the fast memory 108 as input/output buffer space to cache reads and writes to the slow memory 110 in order to improve the performance of the slow memory 110. The use of a RAM disk and/or disk cache space in the fast memory 108 consumes fast memory 108 and can result in a resource shortfall. The process 200 then moves from block 204 to block 208. Block 208 is optional, and may be omitted from the process 200 if desired. In block 208, the controller 104 generates a message for transmission to the information handling system 102. The message offers an option to the user of the information handling system 102 to resubmit the print job at a different compression level. Image data may be stored in different formats corresponding to different compression algorithms, each of which may utilize different amounts of memory space to store the image data. As an example, image data stored in the JPEG format occupies more memory space than image data stored in the bitmap format. Further, different compression algorithms may require different fast memory 108 capacities within the printer 100 to process into a form suitable for transmission to the marking engine 106. Thus, while the same image could be stored in two files of substantially the same size, each in a different format, one file may require substantially more fast memory 108 to store for processing than the other file. By resubmitting a print job at a compression level requiring less memory space to transmit and/or process, the pages of the print job may be able to fit within the capacity of the fast memory 108.

If a RAM disk and/or disk cache is stored in fast memory 108, the message generated by the controller 104 may instead or additionally offer an option relating to the RAM disk or disk cache. The option or options offered to the user of the information handling system 102 may include decreasing the size of the RAM disk or decreasing the size of the disk cache. The RAM disk or disk cache may be decreased to a size of zero, eliminating them. When the print job is resubmitted, the fast memory 108 may then provide adequate capacity for the pages of the print job.

Next, in block 210, the controller 104 determines if the user wishes to resubmit the print job at a different compression level. If the optional block 208 is performed, then block 210 is performed. However, if block 208 is not performed, then block 210 is not performed. If the user wishes to resubmit the print job, he or she may simply do so. Alternately, the user additionally causes a message to be transmitted from the information handling system 102 to the controller 104 indicating that the print job is being resubmitted, such as by clicking a button in a dialog box or other user interface. The user may indicate that the print job is being resubmitted in another way, if desired. The process 200 then moves from block 210 to block 202, as the print job is begun again at a different compression level.

If in block 210 the user does not wish to resubmit the print job, the user informs the controller 104 that the print job is not being resubmitted, such as by clicking a button in a dialog box or other user interface. The process then moves from block 210 to block 212.

In block 212, the printer 100 continues processing the print job. The printer 100 may do so by attempting to print as much of the page as possible. The controller 104 reads the portion of page data that is able to be stored in fast memory 108 and converts it to a form usable by the marking engine 106, such that at least a portion of the page is printed. The controller 104 transmits that data to slow memory 110, moving to step 206, as shown by the dashed line in FIG. 2. Alternately, the controller 104 continues to process the print job by transmitting data to the marking engine 106 that causes the marking engine 106 to print a placeholder page, stating that the page was too large to print. In this way, the printer 100 can continue with the print job as a whole. The controller 104 then skips to the next page. Alternately, the printer 100 generates no printed output associated with any page that is too large to process.

The continued processing performed in block 212 may include updating statistics. As used in this document, the word “statistics” refers to data collected or derived with regard to the ability of the printer 100 to handle a print job. Such statistics may include the number of pages that could not be printed completely, and the largest memory space that would be required in addition to the existing memory 108, 110 in order to print out an incompletely printed page. Different or additional statistics than these may be collected and/or updated, if desired. The statistics may be stored in the controller 104, in the fast memory 108, in the slow memory 110, in a dedicated cache (not shown) associated with the controller 104, or in another device connected to the controller 104.

As one example of updating statistics, for each page of the print job, the controller 104 determines whether that page was printed completely, printed incompletely, or not printed at all, and updates the statistics for the print job to reflect the number of pages that fall into each category. As another example, for each page of the print job that is not printed or that is printed incompletely, due to the size of the page being larger than the fast memory capacity of the printer 100, the controller 104 determines the amount of memory shortfall. The controller 104 may do so in a number of ways. For example, the controller 104 may allow the fast memory 108 to fill with data representing a portion of a page. The controller 104 may then calculate the remaining memory size of the page in a number of ways. As one example, the fast memory 108 may be cleared, after which additional data from that page is admitted to fast memory 108. If that additional data occupies less space than available in the fast memory 108, that amount of data is the size of the memory shortfall. If the fast memory 108 is filled again, the memory shortfall is larger than the total capacity of the fast memory 108. The controller 104 notes this with a counter, register or other device or code for counting, and admits additional remaining data. The process then repeats, allowing the controller to measure the size of print jobs where the memory shortfall is larger than the capacity of the fast memory 108 of the printer 100 by counting the number of times the memory capacity is filled, multiplying that by the memory capacity, and adding the amount of data in the final iteration that occupies less space than available in the fast memory 108. As another example, the memory size of each page of the print job is transmitted from the information handling system 102 to the controller 104.

As another example of updating statistics, the controller 104, or a device associated with it, stores the amount of memory shortfall for each page of the print job for which a memory shortfall occurred. Alternately, the controller 104 only stores a single value for memory shortfall, where that value is the largest shortfall that occurred in the print job. Thus, the controller 104 compares a memory shortfall for a particular page with the stored value of the memory shortfall, replacing the stored value only if that stored value is less that the value of the memory shortfall of the particular page. The process 200 then moves to block 216.

If in block 204 the page received in block 202 is smaller than the capacity of the fast memory 208, the process 200 moves to block 206. In block 206, the controller 104 determines whether the size of the page received in block 202 is larger than the capacity of the slow memory 110 of the printer 100. The controller may make this determination in a number of ways. As an example, the controller 104 writes a complete page from fast memory 108 into slow memory 110. If the write operation is not completed due to the lack of capacity within slow memory 110, the controller 104 recognizes that the page is larger than the capacity of the slow memory 110. Thus, there is a resource shortfall in the printer 100, where slow memory 110 is the resource.

The slow memory 110 is often utilized for a number of uses other than storage of a print job. Fonts, drivers, and other files may be stored in slow memory 110, such that only a small amount of free space is available in slow memory for storing pages of a print job. Thus, the available capacity of the slow memory 110 may be much smaller than its total storage volume.

If the page size is larger than the capacity of the slow memory 110, the process 200 moves to block 208. In block 208, the controller 104 generates a message for transmission to the information handling system 102. The content of this message may be different from the content described above with regard to the fast memory 108. The message offers an option to the user to delete one or more files from the slow memory 110 and/or to perform other operations to increase the capacity of the slow memory 110. By freeing capacity on the slow memory 110 and resubmitting a print job, the pages of the print job may be able to fit within the capacity of the slow memory 110.

The process 200 moves through blocks 210 and 212, which are performed substantially as described above. The process 200 then moves to block 216.

If in block 206 the page size is within the capacity of the slow memory 110, the process 200 moves to block 214, in which the printer 100 prints the page. The process 200 then moves to block 216.

In block 216, if the print job is not complete, the process 200 moves to block 202, and begins to receive the next page of the print job. If the print job is complete, the process 200 moves from block 216 to block 218.

In block 218, the controller 104 generates and communicates a message relating to the resource shortfall in the printer 100. The controller 104 communicates the message via the display 114. Alternately, the controller 104 prints the message on print media via the marking engine 106. Alternately, the controller 104 transmits the message to the information handling system 102.

The message may include one or more items of content, and may be related to the statistics compiled and updated in block 212. With regard to fast memory 108, the message may include a suggestion for a fast memory 108 upgrade, based on the maximum size of the shortfall in fast memory 108. Data regarding possible memory upgrades, such as their size, part number, cost, and the like may be stored in slow memory 110, in the controller 104, or in a device associated with the printer 100. When a shortfall in fast memory 108 is detected, the controller 104 selects at least one memory upgrade from the stored possible memory upgrades, and communicates information regarding that upgrade in the message. The size of the suggested memory upgrade is related to the largest fast memory 108 shortfall. For example, if the largest fast memory 108 shortfall is 14.5 megabytes, and the stored potential upgrades are 8, 24, and 128 megabytes, the controller 104 selects a memory upgrade of 24 megabytes of fast memory 108. The content of the message may indicate that the user could successfully complete the print job if such a memory upgrade were installed. With regard to slow memory 110, the message may include a suggestion for a slow memory 110 upgrade. Determining and communicating such a slow memory 110 upgrade is performed in the same manner described above with regard to fast memory 108.

The controller 104 may maintain a set of statistics across print jobs, where those statistics may include a record of how often resource shortfalls occur, and the sizes of these shortfalls. In this way, the controller 104 may modify its recommendations upon detection of a shortfall in memory 108, 110. For example, if fast memory 108 shortfalls are frequent and are of a certain average size, or have a maximum size, the controller 104 may recommend a fast memory 108 upgrade larger than that average or maximum size, even upon detecting a much smaller memory shortfall in a particular print job. In this way, the printer 100 attempts to suggest an appropriate size for a memory upgrade based on the pattern of usage of the printer 100.

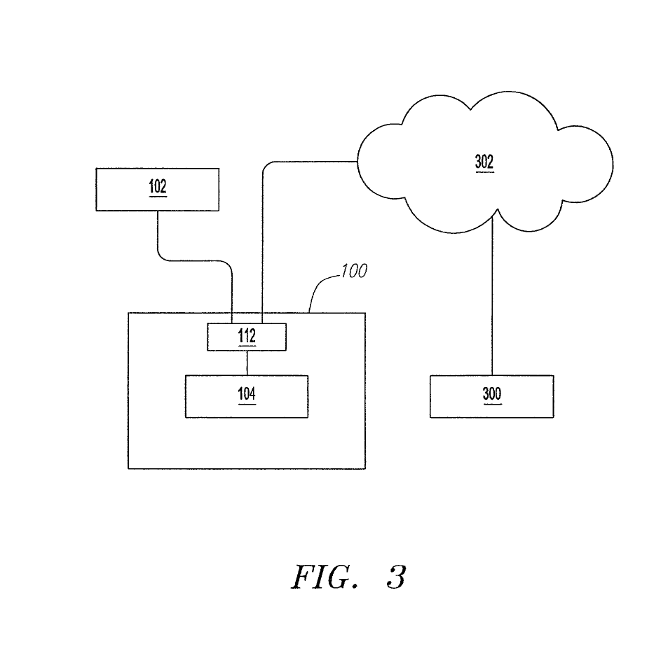

Referring as well to FIG. 3, the printer 100 optionally may be connected to a remote information handling system 300 via a communications network 302. In one embodiment, the printer 100 connects to the communications network 302 via the communications interface 112. The remote information handling system 300 may be any information handling system, such as a personal computer, a mainframe computer, or a server. The communications network 302 may be any communications network, such as a local area network, a wide area network, or the Internet. By connecting the printer 100 to the remote information handling system 300, additional functionality may be obtained, as described in greater detail below. Further, while only a single remote information handling system 300 is shown, additional remote information handling systems 300 may be connected to the printer 100 through the communications network 302. Further, multiple printers 100 may be connected to the remote information handling system 300 via the communications network 302. Thus, multiple types of connections may be made, in order to simplify the use, management and upgrading of a printer 100. For example, the printer 100 may be connected to a remote information handling system 300 at a large facility in which the printer 100 is located, where that remote information handling system 300 is used by a system administrator to monitor the service needs of multiple printers 100 at the facility. As another example, the printer 100 may be connected to a remote information handling system 300 associated with the manufacturer of the printer 100.

Where the printer 100 is connected to the remote information handling system 300 via the communications network 302, block 218 may include actions performed instead or in addition to those described above with regard to block 218. As one example, information generated by the printer 100 relating to the resource shortfall is transmitted to the remote information handling system 300. Such information may include data relating to a particular resource shortfall, raw statistics, or other information. The printer 100 also transmits a unique identifier to the remote information handling system 300 along with the data, in order to uniquely identify the printer 100 that is the source of the data. In this way, the remote information handling system 300 can track data transmitted to it by a number of different printers 100. Alternately, a unique identifier is assigned to a printer 100 by the remote information handling system 300 upon receiving data from that printer 100.

The remote information handling system 300 then takes one or more of a number of actions based on the data received from the printer 100. As one example, the remote information handling system 300 may send an electronic mail message to the information handling system 102, offering and/or describing an upgrade to the printer 100. The electronic mail message may include a price, order form, detailed description, technical specification, or other information. Further, the pricing may reflect discounts or other pricing variances directed to the particular owner of the printer 100. In this way, targeted advertising can be sent to the information handling system 102 based on the data transmitted from the printer 100 to the remote information handling system 300. Alternately, the remote information handing system 300 sends such an electronic mail message to an electronic mail address of a system administrator, manager or other person in charge of the printer 100, rather than to the information handling system 102. Transmitting an electronic mail message to an information handling system over a communications network is standard to one skilled in the art. Alternately, the remote information handling system 300 generates a printed message, flyer, card, brochure, or other such print material for mailing through a postal service to the person responsible for care and upkeep of the printer 100. The contents of the print material may be similar to the contents of the electronic mail message described above.

As another example, the action taken by the remote information handling system 300 includes sending an electronic mail message to a person having sales or marketing responsibilities with regard to the person or entity that utilizes the printer 100. In this way, the sales or marketing representative is informed of the need for an upgrade to the printer 100, so that he or she can make contact with the person responsible for the printer 100 and discuss the possibility of upgrading it. Alternately, the appropriate person responsible for a given group of customers and/or owners of printers 100 has access to a database or other collection of data via the remote information handling system 300 or an associated information handling system, where the database or other collection of data is updated upon receipt of data from the printer 100 at the remote information handling system 300. That data may be utilized in a variety of ways. For example, a sales representative may create a list, by installed location, of all of the printers 100 within a sales territory that transmitted information regarding resource shortfalls to the remote information handling system 300 in the last week. That list can be used by the representative for calling a system administrator or other person at each of those installed locations to discuss printer memory upgrade needs.

If the printer 100 is connected to the remote information handling system 300, the remote information handling system 300 can initiate transmission of data directly to the printer 100. As one example, the remote information handling system 300 transmits new or revised information to the printer 100 relating to the suggested memory 108, 110 upgrades offered by the printer 100. The transmission may be made at fixed time periods, upon occurrence of specified conditions at the printer 100, upon request by the printer 100, and/or at other times or upon other conditions. Such new or revised information may include pricing, new or revised part numbers, new recommendations based on new products or experiences from similar customers, and other data relating to the recommendation made by the printer after experiencing a resource shortfall. For example, the manufacturer may discount a particular fast memory 108 upgrade for a limited time, and the remote information handling system 300 transmits this discount price and its duration to the printer 100. The printer 100 stores this information, and utilizes it to generate a message in response to a resource shortfall, as needed. As another example, the remote information handling system 300 transmits data to the printer 100 that changes or replaces data used by the printer 100 to determine the type, capacity or other characteristics of a suggested memory 108, 110 upgrade. In this way, the criteria applied by the printer 100 with regard to suggested upgrades may be changed as upgrade technology itself changes. As another example, data regarding memory 108, 110 upgrades is not stored at the printer 100 at all; rather, upon determining that a resource shortfall has been detected during a print job, the printer 100 transmits that information to the remote information handling system 300 and receives back a suggested memory upgrade, which is then provided to the user.

Instructions for implementing the method 200 may be provided as a computer program product. A computer program product is a set of instructions for a device such as a controller 104. The computer program product may be stored in the memory 108, 110 of the printer 100 or in a device accessible by the printer 100. The computer program product may be received into the printer 100 via a communications network, a compact disc, a removable hard disk, a removable optical disk, flash memory, or any other hardware, network, device or method capable of storing and/or transmitting data.

Although the invention has been described with reference to particular embodiments, the description is only an example of the invention's application and should not be taken as a limitation. Consequently, various adaptations and combinations of features of the embodiments disclosed are within the scope of the invention as defined by the following claims and their legal equivalents.

What is claimed is:

1. A method for handling a print job at a printer connected to an information handling system, the print job generated at a particular compression level and having at least one page, the printer including a controller, fast memory resources and slow memory resources, the method comprising:
receiving at least one page of the print job at the printer, each page requiring memory resources;
comparing said memory resources required by each received page to memory resources available in the printer; and
measuring the amount of memory resource shortfall, when said memory resources required by one received page are greater than the memory resources available in the printer.

2. The method of claim 1, further comprising continuing to process the print job when said memory resources required by one received page are greater than the memory resources available in the printer.

3. The method of claim 1, further comprising generating a message relating to said memory resource shortfall.

4. The method of claim 1, wherein said memory resource shortfall is a fast memory resource shortfall, and wherein said message comprises offering an option to generate the print job again at a different compression level.

5. The method of claim 1, wherein a portion of the fast memory stores a RAM disk, wherein said memory resource shortfall is a fast memory resource shortfall, and wherein said message comprises offering an option to decrease the size of said RAM disk.

6. The method of claim 1, wherein a portion of the fast memory stores a disk cache, wherein said memory resource shortfall is a fast memory resource shortfall, and wherein said message comprises offering an option to decrease the size of said disk cache.

7. The method of claim 1, wherein said memory resource shortfall is a slow memory resource shortfall, and wherein said message comprises suggesting deletion of data stored in the slow memory.

8. The method of claim 1, wherein said memory resource shortfall is a slow memory resource shortfall, wherein the slow memory includes a RAM disk, and wherein said message comprises suggesting tinstallation of additional slow memory.

9. The method of claim 1, further comprising
storing memory upgrade information; and
suggesting at least one said memory upgrade after measuring said memory shortfall.

10. The method of claim 9, further comprising storing information relating to each said memory shortfall over a period of time, wherein said suggesting is based on said stored information.

11. The method of claim 9, wherein said suggesting comprises transmitting a message to the information handling system.

12. The method of claim 1, further comprising connecting the printer to a remote information handling system.

13. The method of claim 12, further comprising
storing memory upgrade information at the printer; and
receiving an update to said stored memory upgrade information from the remote information handling system.

14. The method of claim 12, further comprising transmitting information relating to said memory shortfall to the remote information handling system.

15. The method of claim 14, further comprising receiving information from the remote information handling system in response to said transmitting.

16. A method for interacting with at least one printer connected to a remote information handling system via a communications network, the method comprising:
receiving at the remote information handling system information from at least one printer relating to a resource shortfall within the printer;
acting on said information.

17. The method of claim 16, wherein said acting comprises transmitting a message.

18. The method of claim 17, wherein said message is transmitted to the at least one printer from which said information was received.

19. The method of claim 16, wherein said acting comprises updating a database including information relating to said at least one printer.

20. A computer program product for handling a print job at a printer, the print job generated under the control of a user at a particular compression level and having at least one page, the printer connected to an information handling system and having a controller connected to memory having a capacity, the computer program product comprising:
instructions for receiving at least one page of the print job at the printer, each page requiring memory resources;
instructions for comparing said memory resources required by each received page to memory resources available in the printer; and
instructions for measuring the amount of memory resource shortfall, when said memory resources required by one received page are greater than the memory resources available in the printer.
